(19) United States
(12) Patent Application Publication
(10) Pub. No.: US 2010/0320743 A1
(43) Pub. Date: Dec. 23, 2010

(54) SECURITY LAMINATE HAVING A SECURITY FEATURE

(75) Inventors: Ingrid Geuens, Emblem (BE); Walther Wouters, Heist op den Berg (BE)

Correspondence Address: LEYDIG VOIT & MAYER, LTD, TWO PRUDENTIAL PLAZA, SUITE 4900, 180 NORTH STETSON AVENUE, CHICAGO, IL, 60601-6731, US

(73) Assignee: AGFA-GEVAERT, Mortsel (BE)

(21) Appl. No.: 12/867,013

(22) PCT Filed: Mar. 26, 2009
(86) PCT No.: PCT/EP2009/053571

§ 371 Date: Aug. 10, 2010

Related U.S. Application Data
(62) Division of application No. 61/041,477, filed on Apr. 1, 2008.

(30) Foreign Application Priority Data
Apr. 1, 2008 (EP) 08103

(51) Int. Cl. B42D 15/10; B32B 7/02

(52) U.S. Cl. 283/70; 428/213; 283/75; 283/57

(57) ABSTRACT

A security laminate comprising a plurality of lamellae and layers, wherein at least one of the lamellae is a biaxially stretched polyethylene terephthalate film, and wherein the ratio of the thickness of the one or more biaxially stretched polyethylene terephthalate films over the total thickness of the security laminate is at least 0.21. A method for detecting the falsification of such security laminates by a sound characteristic is also disclosed.

### FIELD OF INVENTION

This invention relates to security laminates having a security feature, namely the capability of producing an identifiable sound.

### BACKGROUND OF THE INVENTION

The term “security laminate” encompasses stand-alone security objects including identification cards and bank notes. The term “identification card” encompasses cards requiring bearer identification and range from passports to national identity cards ID-cards) to establish the national identity of their civilians to visa's to cards involved in the electronic transfer of money such as bank cards, cheque cards, pay cards, credit cards, debit cards and shopping cards to security cards authorizing access to the bearer of the card to particular areas such as a company (employee ID card), the military, a public service, the safe deposit departments of banks, etc. to social security cards to driving licenses to health care cards to membership cards of clubs and societies.

Poly(vinyl chloride) (PVC) and/or poly(vinyl chloride/acetate), polyesters, polyethylenes and polycarbonates are known for use as identification card materials. PVC-based cards have been the most widely used, but such cards have a short lifetime of only one to two years due to the marginal physical properties of PVC. PVC is also known to readily absorb plasticizers from other objects thereby further degrading its physical properties.

JP 2007-268712A discloses a sheet, which produces a sound by horizontally rubbing an upper side sheet and a lower side sheet against one another, which are pilingly formed by doubling the paper itself of various kinds of security papers equipped with antifalsification marks or blind marks. Unevennesses are arranged in set arrangement on the surfaces of the upper side sheet and of the lower side sheet in some portion of the sheet, the unevenness is made of a pair of a convexity and a concavity under the state that the distance of one pitch comprising a pair of the convexity and the concavity is divided in the distance of the upper bottom part of the convexity and the distance of the lower bottom part of the concavity under the condition that the length of the lower bottom part is formed longer than the length of the upper bottom part. In this sheet, unique sound is produced by changing the convexity or its shape, its direction and the three dimensions of the convexity.

US 2007/0017647A1 discloses a security paper for producing value documents, exemplified by bank notes, passports or identification documents, comprising a flat substrate provided at least partly with a dirt-repellent protective layer for extending the life time and fitness for circulation, wherein the protective layer comprises at least two lacquer layers, a first lower one of said lacquer layers being formed by a physically drying lacquer layer applied to the substrate which makes contact with the substrate therebelow and closes its pores, and a second upper one of said lacquer layers protecting the substrate from physical and chemical influences, wherein the second upper lacquer layer is formed by a radiation-curing and/or physically drying lacquer layer and the composition of the upper lacquer layer is selected with respect to brittleness and surface tension so as to obtain a predetermined haptics of the security paper, in particular a predetermined smoothness, sound and/or flexural stiffness.

GB 2400074A discloses a sheet having two opposing surfaces, said sheet having at least two areas displaced laterally from each other, said areas being provided with surface relief in the form of a plurality of lines raised relative to the normal plane of the sheet, the sheet being foldable to enable the at least two areas to be brought into contact with each other and rubbed relative to each other thereby giving rise to an audible sound and a distinct tactile effect.

WO 00/018591A1 discloses a security document comprising a sheet-like substrate having one or more layers containing particles for forming an authentification device in a first location on a security document, the particles having at least a first dimension in the range of 1 to 200 nm, wherein the particles are selected from materials to reflect incident sound or acoustic waves and from materials that absorb light or sound energy and subsequently re-emit said energy acoustically.

U.S. Pat. No. 4,480,177 discloses a method of treating paper money with opposed surfaces and a central portrait printed on one of the surfaces for the purpose of identifying same comprising the steps of: applying to that surface of the paper money opposite the surface on which the central portrait is printed a first treating material to form a source identifying code thereon where said first treating material is normally invisible but is rendered visible under ultra violet light; and applying a mixture of liquid adhesive and gritty material over a portion of the central portrait, and allowing the mixture to dry to form a layer defining a textured surface thereon distinguishable by feel from that of the surface of the paper money to aid in the detection of the paper money during the handling thereof by bank personnel, wherein the method further comprises the steps of affixing an audible sound generating mechanism to the surface of the paper money where the sound generating mechanism includes activation means and is constructed and arranged to generate an audible sound signal starting a prescribed period of time after actuation of said activation means to assist in locating the paper money; arranging the paper currency with other pieces of paper currency to form a packet where the sound generating mechanism is concealed within the packet; and enclosing the packet in a strap to maintain the integrity of the packet.

The prior art fails to provide a means of distinguishing security laminate from one another without recourse to complicated detection systems. There is therefore a need for a security laminate which can be distinguished from other security laminates without recourse to complicated detection systems.

### ASPECTS OF THE INVENTION

It is therefore an aspect of the present invention to provide a security laminate which can be distinguished from other security laminates without recourse to complicated detection systems.

It is also an aspect of the present invention to provide a process for distinguishing different security laminates.

Further aspects of the present invention will become apparent from the description hereinafter.

### SUMMARY OF THE INVENTION

The inventors have surprisingly found that security laminates comprising at least one particular film can be distinguised from security laminates with alternative films on the basis of the human-recognizable sound that the security laminates make in particular the sound that they make upon being dropped upon a substantially flat surface, despite the at least one film being associated with layers and lamellae of different materials such as amorphous polyesters, polycarbonate or polyvinyl chloride. Examples of such films are films with an elasticity modulus greater than 3.3 GPa and/or with a tensile strength of at least 90 MPa and/or a compression strength of at least 105 MPa.

Aspects of the present invention are realized by a security laminate as defined by claim 1.

Aspects of the present invention have also been realized by a method for detecting falsified security laminates comprising the steps of: i) dropping the security laminate with a corner downmost from a height of about 5 cm on a substantially flat surface; ii) hearing the sound made upon dropping the security laminate on a substantially flat surface; iii) associating the sound made upon dropping the security laminate on a substantially flat surface with security laminates having at least one film having an elasticity modulus greater than 3.3 GPa and/or with a tensile strength of at least 90 MPa and/or a compression strength of at least 105 MPa.

Aspects of the present invention have also been realized by method for detecting falsified security laminates comprising the steps of:

a) providing a security laminate;
b) suspending the security laminate from one corner by a crocodile clip at the end of a wire;
c) detecting a sound characteristic of the security laminate set in vibration with a hammer; and
d) comparing the sound characteristic with the sound characteristic of an authentic security laminate.

Preferred embodiments are disclosed in the dependent claims.

### DETAILED DESCRIPTION OF THE INVENTION

### Definitions

The term film, as used in disclosing the present invention, means a self-supporting polymer-based sheet, which may be associated with adhesion layers e.g. subbing layers.

The term lamella in the terms polymeric lamellae and polyester lamella, as used in disclosing the present invention, means a thin polymeric sheet optionally provided with an adhesive system used in producing laminates using pressure optionally together with heat. The term “lamellae” includes films and prelaminates.

The term layer system, as used in disclosing the present invention, means one or more layers contiguous with one another.

The term chlorinated ethylene, as used in disclosing the present invention, means ethylene substituted with at least one chlorine atom e.g. vinyl chloride, vinylidene chloride, 1,2-dichloro-ethylene, trichloroethylene and tetrachloroethylene. 1,2-dichloro-ethylene, trichloroethylene and tetrachloroethylene Trichloroethylene and tetrachloroethylene are all much more difficult to polymerize than vinyl chloride or vinylidene chloride.

PET is an abbreviation for polyethylene terephthalate.

PET-C is an abbreviation for biaxially stretched polyethylene terephthalate.

PETG is an abbreviation for polyethylene terephthalate glycol, the glycol indicating glycol modifiers i.e. partial replacement of ethylene glycol by alternative glycols such as 1,4-cyclohexane-dimethanol or neopentyl glycol which minimize brittleness and premature aging that occur if unmodified amorphous polyethylene terephthalate (APET) is used in the production of cards.

O-PETG is an abbreviation for opaque PETG opacified with 6% by weight titanium dioxide.

### Security Laminates

Aspects of the present invention are realized by a security laminate comprising a plurality of lamellae and layers, wherein at least one of the lamellae is a film, the security laminate being capable of producing a sound characteristic of the nature of the film without contact between the laminates or of part of the laminate with another part of the laminate.

In a preferred embodiment of the security laminate, according to the present invention, the security laminate is exclusive of paper. Paper is known to readily absorb water and hence facilitate delamination and falsification of the security laminate.

In a preferred embodiment of the security laminate, according to the present invention, the sound can be recognized by a human as being characteristic of the presence of the at least one film upon the laminate being dropped upon a substantially flat surface.

In a preferred embodiment of the security laminate, according to the present invention, the at least one film is at least one of the outermost lamellae in the security laminate.

In a preferred embodiment of the security laminate, according to the present invention, a second of the plurality of lamellae is a second film of the same type of film as the film although optionally differing in composition and film thickness.

In a preferred embodiment of the security laminate, according to the present invention, a second of the plurality of lamellae is a second film of the same type of film as the film although optionally differing in composition and film thickness and wherein the film and the second film are the outermost lamellae of the security laminate.

In a preferred embodiment of the security laminate, according to the present invention, the security laminate is a banknote.

In a preferred embodiment of the security laminate, according to the present invention, the security laminate is an identification card.

In a preferred embodiment of the security laminate, according to the present invention, the plurality of lamellae further include at least one lamella selected from the group consisting of amorphous polyester lamellae, crystalline polyester lamellae, polycarbonate lamellae, polyolefin lamellae, polyvinyl chloride lamellae and polysulphone lamellae.

The security laminates of the present invention are readily suited to making a direct pre-cut card with improved physical properties. The ID card stock of the invention provides improved flexural durability over an extended period of time vs. PVC, while retaining good stiffness and impact strength.

Pre-cut ID card stock can be easily produced by conventional methods using the above-described composite film structure in the conventional shape, size, e.g., 54.5 mm×86 mm, and having a thickness of about 0.8 mm. A pre-cut card stock is one which is made to the card size specifications before printing and exits the printer system without any further trimming or cutting required. An overcoat laminate may be applied after printing if desired.

The thickness of both the polymeric core substrate and oriented polymeric film is variable, but the overall thickness is usually in the range of 685 to 838 μm. The outer surfaces of the ID card stock can be printed with dye images or text. Optionally, non-varying information, such as lines, line segments, dots, letters, characters, logos, guilloches, etc., can be printed on the polymeric core substrate by non-thermal dye transfer methods such as flexo or offset printing before attaching the polymeric core substrate to the oriented polymeric film or films carrying the external dye-receiving layer or layers.

The composite ID card stock of the invention can also be readily milled for placement of a memory chip. Alternatively, the polymeric core substrate and an oriented polymeric film can be pre-punched before attaching to provide a suitable site for a memory chip or in the case of contactless applications the chip can be interlaminated.

### Film

Aspects of the present invention are realized by a security laminate comprising a plurality of lamellae and layers, wherein at least one of the lamellae is a film, the security laminate being capable of producing a sound characteristic of the nature of the film without contact between the laminates or of part of the laminate with another part of the laminate.

In a preferred embodiment of the security laminate, according to the present invention, the at least one film has an elasticity modulus greater than 3.3 GPa.

In a preferred embodiment of the security laminate, according to the present invention, the at least one film has an elasticity modulus with a tensile strength of at least 90 MPa.

In a preferred embodiment of the security laminate, according to the present invention, the at least one film has a compression strength of at least 105 MPa.

Suitable films include axially stretched crystalline polyesters, certain nylons, certain polyamide-imides, certain polyimides and certain polyphenylene sulphides.

In a preferred embodiment of the security laminate, according to the present invention, the at least one film is a linear axially stretched crystalline polyester film.

Crystalline linear polyesters are well known to those skilled in the art and is obtained by condensing one or more dicarboxylic acids or their lower (up to 6 carbon atoms) diesters, e.g., terephthalic acid, isophthalic acid, phthalic acid, 2,5-, 2,6- or 2,7-naphthalenedicarboxylic acid, succinic acid, sebacic acid, adipic acid, azelaic acid, 4,4′-diphenyldicarboxylic acid, hexahydroterephthalic acid or 2-bis-p-carboxyphenoxyethane (optionally with a monocarboxylic acid, such as pivalic acid), the corresponding dicarboxylic acid dialkyl ester or lower alkyl ester with one or more glycols, e.g., ethylene glycol, 1,3-propanediol, 1,4-butanediol, neopentyl glycol and 1,4-cyclohexanedimethanol. In a preferred embodiment, the polyester polymer is obtained by condensing terephthalic acid or 2,6-naphthalenedicarboxylic acid or their dimethyl esters with ethylene glycol. In another preferred embodiment, the polymer is PET. The PET film prepared from the above-described composition must be oriented. In a preferred embodiment, the PET film is biaxially-oriented. Such a process is described in many patents, such as GB 838,708, the disclosure of which is hereby incorporated by reference. These techniques are well known to those skilled in the art.

In a preferred embodiment of the security laminate, according to the present invention, the at least one film is a linear axially stretched crystalline polyester film, the linear crystalline polyester consisting essentially of aliphatic dimethylene units, optionally alicyclic dimethylene units; and phthalate units and/or naphthalate units.

In a preferred embodiment of the security laminate, according to the present invention, the at least one film is a linear axially stretched crystalline polyester film, the linear crystalline polyester comprising monomer units selected from the group consisting of terephthalate units, isophthalate units, naphthalate units, ethylene units, neopentylene units, 1,4-cyclohexane dimethylene units and —CH₂CH₂OCH₂CH₂— units being preferred e.g. polyethylene terephthalate (PET), polyethylene naphthalate (PEN).

In a preferred embodiment of the security laminate, according to the present invention, the at least one film is a linear axially stretched crystalline polyester film, the linear crystalline polyester, the linear crystalline polyester consisting essentially of terephthalate, isophthalate and ethylene units.

security laminate is an identification (identity) card.

In a preferred embodiment of the security laminate, according to the present invention, the at least one film has a thickness in the range of 12 μm to 500 μm, with a thickness in the range of 35 μm to 300 μm being preferred.

### Process for Recognizing a Security Laminate

Aspects of the present invention have also been realized by a method for detecting falsified security laminates comprising the steps of: i) dropping the security laminate with a corner downmost from a height of about 5 cm on a substantially flat surface; ii) hearing the sound made upon dropping the security laminate on a substantially flat surface; iii) associating the sound made upon dropping the security laminate on a substantially flat surface with security laminates having at least one film having an elasticity modulus greater than 3.3 GPa and/or with a tensile strength of at least 90 MPa and/or a compression strength of at least 105 MPa.

### INDUSTRIAL APPLICATION

The security laminates, according to the present invention, can be bank notes or identity documents such as ID-cards, visa's, passports, ID-cards and passports, bank cards, cheque cards, pay cards, credit cards, debit cards, loyalty cards, shopping cards, security cards authorizing access to the bearer of the card, social security cards, driving licenses, healthcare cards membership cards of clubs and societies.

The invention is illustrated hereinafter by way of COMPARATIVE EXAMPLES and INVENTION EXAMPLES. The percentages and ratios given in these examples are by weight unless otherwise indicated.
MEK=methyl ethyl ketone
KIESELSOL™100F=a 36% aqueous dispersion of colloidal silica from BAYER;
MERSOLAT™H=an alkyl sulphonate surfactant from BAYER;
Arkopal™ NO060=a nonyl-phenyl-oxy-polyethylene-glycol(EO 6) from Avecia
Arkopon™ T8015=a sodium salt of N-methyl-N-2-sulfoethyl-oleylamide from Avecia, supplied as a 40% concentrate

### Adhesion Layers:

### Subbing Layer 1:

| | |
|---|---|
| copolymer of vinylidene chloride, methyl acrylate and | 151 |
| itaconic acid 88:10:2 by weight [mg/m²]: | |
| colloidal silica (KIESELSOL ™ 100F) [mg/m²]: | 35 |
| Mersolat ™ H [mg/m²]: | 0.75 |
| Coating weight [mg/m²]: | 187 |
| Coating thickness [μm]: | ca. 0.19 |

### Subbing Layer 2:

| | |
|---|---|
| copolymer of vinylidene chloride, methyl acrylate and | 147.3 |
| itaconic acid 88:10:2 by weight [mg/m²]: | |
| poly(3,4-ethylenedioxythiophene)/PSS [mg/m²]: | 2.58 |
| colloidal silica (KIESELSOL ™ 100F) [mg/m²]: | 16.4 |
| Mersolat ™ H [mg/m²]: | 0.74 |
| Coating weight [mg/m²]: | 167 |
| Coating thickness [μm]: | ca. 0.17 |

The 63 μm PET-C film was provided on one side with subbing layer 1 and an adhesion layer with the following composition:

| | |
|---|---|
| Gelatin [mg/m²] | 380 |
| colloidal silica (KIESELSOL ™ 100F) [mg/m²]: | 340.7 |
| Arkopon ™ T8015 [mg/m²]: | 3.33 |
| Arkopal ™ N060 [mg/m²]: | 6.67 |
| 1 μm diameter polymethylmethacrylate particles [mg/m²]: | 0.04 |
| Coating weight [mg/m²]: | 730.7 |
| Coating thickness [μm]: | ca. 0.73 |

and on the other side with subbing layer 2 and an adhesion layer with the following composition:

| | |
|---|---|
| Gelatin [mg/m²] | 380 |
| colloidal silica (KIESELSOL ™ 100F) [mg/m²]: | 340.8 |
| Arkopon ™ T8015 [mg/m²]: | 3.3 |
| Arkopal ™ N060 [mg/m²]: | 6.7 |
| 3 μm diameter polymethylmethacrylate particles | 1.7 |
| Coating weight [mg/m²]: | 732.5 |
| Coating thickness [μm]: | ca. 0.73 |

and then a layer of Liofol™ UK 3640 with Liofol™ hardener 6800 both from Henkel was coated from a methylethylketone solution. The PETG-film was then laminated thereon using a roll laminator at room temperature.

The 23 μm PET-C film had no subbing layer and was provided with an adhesion layer of Liofol™ UK 3640 with Liofol hardener 6800 via which it was laminated to the 35 μm PETG-film.

### Laminate Precursors (or Prelaminates):

### Laminate Precursor I (PrelamI):

A 63 μmPET-C film provided with subbing layer 1 on one side and subbing layer 2 (antistatic layer) on the other side was coated on one side with a sequence of layer consisting of a gelatinous layer, a gelatinous DTR-receiving layer and a protective layer resulting in the following configuration:
   protective layer/gelatinous DTR-receiving layer containing a DTR-image/gelatinous layer/63 μmPET-C/polyurethane-adhesive

### Laminate Precursor II (PrelamII):

A punched 500 μm opaque PETG film with a chip was sandwiched between two 35 μm opaque PETG films and laminated.
   35 μmO-PETG/500 μmO-PETG punched+module in hole/35 μm O-PETG

### Laminate Precursor III (PrelamIII):

A 63 μmPET-C film provided with subbing layer 1 on one side and subbing layer 2 (antistatic layer) on the other side was coated on one side with a sequence of layer consisting of a gelatinous layer and a protective layer resulting in the following configuration:
   35 μmPETG/polyurethane-adhesive/63 μmPET-C/gelatinous layer/protective layer

### Protective Laminate:

A 30 μmPE film was laminated to a 23 μmPET-C film with Liofol UK 3640 with Liofol hardener 6800 resulting in a protective 30 μmPE/23 μmPET-C laminate.

### Self-Laminated ID-Cards:

The PETG ID-card used in these measurements was built up by laminating a sandwich of a 200 μm film, a 500 μm film and a 100 μm film between two metal plates with silicone paper in between to prevent sticking in an OASYS™ OLA6/7 laminator from OASYS Technologies Ltd with settings such that a pressure of 17 units was first applied while the temperature was increased from room temperature to 135° C., then held at 135° C. for 150s, then reduced to 130° C. and finally cooled to 50° C. at an increased pressure of 22 units.

### Example 1

Although it was possible to aurally distinguish between security laminates having at least one film has an elasticity modulus greater than 3.3 GPa and/or with a tensile strength of at least 90 MPa and/or a compression strength of at least 105 MPa and those security laminates that did not by performing the process comprising the steps of:
i) dropping the security laminate with a corner downmost from a height of about 5 cm on a substantially flat surface;
ii) hearing the sound made upon dropping the security laminate on a substantially flat surface; and
iii) associating the sound made upon dropping the security laminate on a substantially flat surface with security laminates having at least one film has an elasticity modulus greater than 3.3 GPa and/or with a tensile strength of at least 90 MPa and/or a compression strength of at least 105 MPa;
   it was not possible to detect this difference reproducibly using a Larson 824 sonometer. Alternative methods were then sought to verify the difference in sound made by security laminates according to the present invention compared with those outside the scope of the present invention. Two experimental configurations were evaluated.

### Experiment I

In the first experiment a short side of a security laminate having an ID-1 format according to ISO 7810 was clamped and the sound was detected when the top of the card was bent back and then released allowing the card to vibrate.

### Experiment II

In the second experiment the security laminates having an ID-1 format according to ISO 7810 were suspended from one corner by a crocodile clip at the end of a wire and the sound detected when the security laminate was set in vibration with a hammer.

The experimental configuration of EXPERIMENT II gave much larger differences between the detected sound signals. All the results reported below were performed with the configuration according to EXPERIMENT II.

Experimental reproducibility required that the cards all be suspended in the same way and that the card was set in vibration using the same force and speed. The induced sound was detected with a Bruel & Kjaer Type 4133 microphone at a distance of 50 mm from the ID-card at rest, with a Bruel & Kjaer 2639 preamplifier and a DIFA Scadus 305 acquisition system. A Bruel & Kjaer type 4230 calibrator was used to calibrate the system.

The polycarbonate ID-card, Ruhlamat Cartes 2007, induced a significantly different sound spectrum compared with PVC ID-cards, EVOLIS and self-laminated ID-cards, self-laminated PETG ID-cards and ID-cards with biaxially stretched PET {PET-C] lamellae. ID-cards with biaxially stretched PET lamellae and PVC ID-cards induced different sound spectra. The sound spectra induced by full PVC ID-cards and full PETG ID-cards were fairly similar.

The following ten ID-card configurations with PET-C were evaluated:

| | |
|---|---|
| ID-I: | 23 μm PET-C/30 μm PE/63 μm PET-C/35 μm PETG/500 μm O-PETG/ |
| | 35 μm PETG/63 μm PET-C/30 μm PE/23 μm PET-C |
| ID-II: | 23 μm PET-C/35 μm PETG/50 μm O-PETG/500 μm O-PETG/100 μm O-PETG/ |
| | 35 μm PETG/23 μm PET-C |
| ID-III: | 63 μm PET-C/35 μm PETG/35 μm PETG/500 μm O-PETG/35 μm PETG/ |
| | 35 μm PETG/63 μm PET-C |
| ID-IV: | 100 μm PET-C/35 μm PETG/500 μm PETG/35 μm PETG/100 μm PET-C |
| ID-V: | 175 μm PET-C/35 μm PETG/200 μm O-PETG/100 μm O-PETG/ |
| | 35 μm PETG/35 μm PETG/175 μm |
| ID-VI: | protective laminate/prelamI/prelamII/prelamIII/protective |
| | laminate (see above) |
| ID-VII: | 23 μm PET-C/35 μm PETG/100 μm O-PVC/100 μm O-PVC/100 μm O-PVC/100 μm O- |
| | PVC/100 μm O-PVC/100 μm O-PVC/100 μm O-PVC/35 μm PETG/23 μm PET-C |
| ID-VIII: | 63 μm PET-C/35 μm PETG/100 μm O-PVC/100 μm O-PVC/100 μm O-PVC/100 μm O- |
| | PVC/100 μm O-PVC/35 μm PETG/63 μm PET-C |
| ID-IX: | 100 μm PET-C/35 μm PETG/100 μm O-PVC/100 μm O-PVC/100 μm O- |
| | PVC/100 μm O-PVC/100 μm O-PVC/35 μm PETG/100 μm PET-C |
| ID-X: | 175 μm PET-C/35 μm PETG/100 μm O-PVC/100 μm O-PVC/100 μm O- |
| | PVC/35 μm PETG/175 μm |

The results obtained with polycarbonate, PETG and PVC ID-cards together with those obtained with the ID-card configurations of ID-I to ID-X are given in Table 1 and Table 2 respectively.

TABLE 1

| | | | | frequency |
|---|---|---|---|---|
| | Frequency | | | maximum |
| | interval | | Maximum peak | amplitude |
| | [Hz] | Amplitude | amplitude | [Hz] |
| Polycarbonate | 750-950 | 1.00 × 10⁻³ | 2.10 × 10⁻² | 140 |
| ID-card | 1150-1500 | 2.00 × 10⁻³ | | |
| | 1700-2300 | 2.00 × 10⁻³ | | |
| ID-I | 570-900 | 1.30 × 10⁻³ | 2.60 × 10⁻³ | 170 |
| PET-C/PETG | 900-1300 | 5.30 × 10⁻⁴ | | |
| | 1300-1850 | 1.60 × 10⁻³ | | |
| | 2100-2800 | 4.00 × 10⁻⁴ | | |
| PETG ID-card | 650-900 | 1.00 × 10⁻³ | 1.30 × 10⁻² | 128 |
| self-laminated | 900-1450 | 1.30 × 10⁻³ | | |
| | 1450-2000 | 1.30 × 10⁻³ | | |
| PVC ID-card | 450-700 | 1.14 × 10⁻³ | 6.80 × 10⁻³ | 128 |
| | 700-850 | 4.20 × 10⁻⁴ | | |
| | 1000-1600 | 1.14 × 10⁻³ | | |
| | 1600-2250 | 1.14 × 10⁻³ | | |
| Full PVC | 500-800 | 1.60 × 10⁻³ | 7.00 × 10⁻³ | 145 |
| self-laminated | 800-1100 | 5.30 × 10⁻⁴ | | |
| | 1100-1650 | 1.00 × 10⁻³ | | |
| | 1850-2600 | 1.33 × 10⁻³ | | |

The PET-C card of ID-I induced sound with a frequency at maximum amplitude of 170 Hz, which was considerably higher than the 140 Hz and 128 Hz of the polycarbonate and PETG ID-cards and also higher than those observed with the EVOLIS and self-laminated PVC ID-cards. moreover, the ratio of maximum peak amplitude to the average of the amplitudes at higher frequencies is also characteristic of the four types of ID-cards, being 12.6 for the polycarbonate card, 10.8 for the PETG card, an average of 6.7 for the PVC cards and only 2.6 for the ID-I card. However, the frequencies at which the maximum amplitude was observed differed between the two PVC ID-cards with a frequency of 128 Hz being observed for an EVOLIS ID-card and one of 145 Hz being observed for the self-laminated ID-card.

Closer examination of the sound frequency spectra for the cards showed that not only was the frequencies at maximum amplitude different for PET-C cards, but the whole sound spectra for PET-C cards was very different compared with polycarbonate cards or PVC-cards i.e. there is little or no overlap. There is a degree of overlap in the case of the sound frequency spectra for polycarbonate and PETG and very considerable overlap in the case of polycarbonate and PVC cards.

TABLE 2

| | PET-C film | Frequency | | | frequency at |
|---|---|---|---|---|---|
| | thickness | interval | | Maximum | maximum |
| | [μm] | [Hz] | Amplitude | amplitude | amplitude [Hz] |
| ID-II | 23 | 700-850 | 1.00 × 10⁻³ | 1.35 × 10⁻² | 120 |
| | | 900-1300 | 1.30 × 10⁻³ | | |
| | | 1600-2000 | 1.14 × 10⁻³ | | |
| ID-III | 63 | 800-1100 | 7.10 × 10⁻⁷ | 1.20 × 10⁻² | 145 |
| | | 1100-1700 | 1.42 × 10⁻³ | | |
| | | 1900-2300 | 1.00 × 10⁻³ | | |
| ID-IV | 100 | 900-1100 | 8.60 × 10⁻⁴ | 8.00 × 10⁻³ | 160 |
| | | 1100-1700 | 1.30 × 10⁻³ | | |
| | | 1900-2600 | 1.60 × 10⁻³ | | |
| ID-V | 175 | 600-950 | 1.73 × 10⁻³ | 5.00 × 10⁻³ | 180 |
| | | 950-1200 | 5.30 × 10⁻⁴ | | |
| | | 1200-2000 | 1.20 × 10⁻³ | | |
| | | 2000-2800 | 1.47 × 10⁻³ | | |
| ID-VI | 63 | 800-1100 | 5.30 × 10⁻⁴ | 1.05 × 10⁻² | 145 |
| | | 1100-1800 | 1.20 × 10⁻³ | | |
| | | 1800-2600 | 1.20 × 10⁻³ | | |
| ID-VII | 23 | 850-1100 | 5.30 × 10⁻⁴ | 7.75 × 10⁻³ | 145 |
| | | 1100-1700 | 8.60 × 10⁻⁴ | | |
| | | 1800-2500 | 1.07 × 10⁻³ | | |
| ID-VIII | 63 | 850-1050 | 6.70 × 10⁻⁴ | 7.75 × 10⁻³ | 145 |
| | | 1050-1700 | 1.13 × 10⁻³ | | |
| | | 1850-2300 | 1.60 × 10⁻³ | | |
| ID-IX | 100 | 580-900 | 1.60 × 10⁻³ | 8.00 × 10⁻³ | 165 |
| | | 1150-2000 | 5.30 × 10⁻⁴ | | |
| | | 2000-3000 | 1.30 × 10⁻³ | | |
| ID-X | 175 | 600-950 | 2.13 × 10⁻³ | 5.00 × 10⁻³ | 165 |
| | | 950-1200 | 6.70 × 10⁻⁴ | | |
| | | 1200-1900 | 9.30 × 10⁻⁴ | | |
| | | 2100-2800 | 1.73 × 10⁻³ | | |

The sound frequency spectra for ID-III and IV-VI completely overlapped.
ID-II to ID-V: PET-C with PETG

In the case of ID-card configurations ID-II to ID-V with PET-C with PETG, the frequency at which the maximum amplitude was observed shifted from 120 Hz to 180 Hz as the thickness of the PET-C film increased from 23 μm to 175 μm. The frequency at maximum amplitude for ID-II of 120 Hz with a PET-C film thickness of 23 μm was indistinguishable from that for PETG ID-cards of 128 Hz. The ratio of maximum peak amplitude to the average of the amplitudes at higher frequencies decreased from 11.8 to 4.0 as the thickness of the PET-C film increased from 23 μm to 175 μm, again showing the increasing presence of PET-C.

In the case of ID-II, ID-III, ID-IV and ID-V not only the frequency at maximum amplitude, but also the whole sound frequency spectrum is shifted to high frequencies with increasing PET-C film thickness. The largest shift of the sound frequency spectrum was observed between ID-II and ID-III, there being little overlap, whereas the degree of overlap increased as the thickness of the PET-C film increased.

ID-VI: PET-C with Polycarbonate and PETG

The frequency at which the maximum amplitude was observed in the case of ID-card configuration ID-VI with 63 μm thick PET-C films with polycarbonate and PETG was 145 Hz, which was clearly different from the 140 Hz observed with the polycarbonate ID-card. The ratio of maximum peak amplitude to the average of the amplitudes at higher frequencies was 10.8 which was identical to the value for the PETG card

ID-VII to ID-X: PET-C with PVC and PETG

In the case of ID-card configurations ID-VII to ID-X with PET-C with PVC and PETG, the frequency at which the maximum amplitude was observed shifted from 145 Hz to 165 Hz as the thickness of the PET-C film increased from 23 μm to 175 μm. However, these frequencies at maximum amplitude are all greater than either the frequency at maximum amplitude for PVC ID-cards or PETG ID-cards, which were both 128 Hz. The frequency at maximum amplitude for ID-VII and ID-VIII of 145 Hz with a PET-C film thickness of 23 μm and 63 μm respectively was indistinguishable from that for self-laminated PVC ID-card of 145 Hz. The ratio of maximum peak amplitude to the average of the amplitudes at higher frequencies decreased from 9.6 to 3.7 as the thickness of the PET-C film increased from 23 μm to 175 μm, again showing the increasing presence of PET-C.

### CONCLUSIONS

These experiments showed that the aural detection of the difference in sound is confirmed by measurements according to Experiment II at least for PET-C film thicknesses of 63 μm or greater. They were unable to provide corroborative evidence in the case of ID-card configurations with PET-C film thicknesses of 23 μm except on the basis of the sound frequency spectrum as a whole. This was due to the directional nature of the sound detection compared with the spatial sound detection of a human ear and hence the higher sensitivity of the human ear compared with microphone-based detection systems.

Microphone-based detection systems can however be used efficiently to detect falsified security laminates if the PET-C ratio, i.e. the ratio of the thickness of biaxially stretched polyethylene terephthalate film over the total thickness of the security laminate, is at least 0.21. This is clearly shown by Table 3. The security laminates ID-1, ID-IV, ID-V, ID-IX and ID-X, all having a PET-C ratio of at least 0.21, exhibit a frequency maximum amplitude of 160 Hz or more. Such frequency maximum amplitudes clearly differentiate them from ‘conventional’ security laminates either lacking biaxially stretched polyethylene terephthalate film or only containing PET-C in a minor amount.

TABLE 3

| | frequency | | | |
|---|---|---|---|---|
| | maximum | Thickness | Total | |
| | amplitude | PET-C | Thickness | PET-C |
| Sample | (Hz) | (μm) | (μm) | Ratio |
| Polycarbonate | 140 | 0 | not measured | 0.00 |
| ID-I | 170 | 172 | 802 | 0.21 |
| PETG ID-card | 128 | 0 | 800 | 0.00 |
| PVC ID-card | 128 | 0 | not measured | 0.00 |
| Full PVC | 145 | 0 | not measured | 0.00 |
| ID-II | 120 | 46 | 766 | 0.06 |
| ID-III | 145 | 126 | 766 | 0.16 |
| ID-IV | 160 | 200 | 770 | 0.26 |
| ID-V | 180 | 350 | 755 | 0.46 |
| ID-VI | 145 | 172 | 840 | 0.20 |
| ID-VII | 145 | 46 | 816 | 0.06 |
| ID-VIII | 145 | 126 | 696 | 0.18 |
| ID-IX | 165 | 200 | 770 | 0.26 |
| ID-X | 165 | 350 | 720 | 0.49 |

The present invention may include any feature or combination of features disclosed herein either implicitly or explicitly or any generalisation thereof. In view of the foregoing description it will be evident to a person skilled in the art that various modifications may be made within the scope of the invention.

1-11. (canceled)

12. A security laminate comprising a plurality of lamellae and layers, wherein at least one of the lamellae is a biaxially stretched polyethylene terephthalate film, and wherein the ratio of the thickness of the one or more biaxially stretched polyethylene terephthalate films over the total thickness of the security laminate is at least 0.21.

13. The security laminate according to claim 12, wherein the security laminate is exclusive of paper.

14. The security laminate according to claim 12, wherein the at least one biaxially stretched polyethylene terephthalate film is one of the outermost lamellae in the security laminate.

15. The security laminate according to claim 13, wherein the at least one biaxially stretched polyethylene terephthalate film is one of the outermost lamellae in the security laminate.

16. The security laminate according to claim 12, wherein a second of the plurality of lamellae is a second biaxially stretched polyethylene terephthalate film, said second film optionally differing in film thickness.

17. The security laminate according to claim 16, wherein the two biaxially stretched polyethylene terephthalate films are the outermost lamellae of the security laminate.

18. The security laminate according to claim 12, wherein the security laminates have an ID-1 format according to ISO 7810.

19. The security laminate according to claim 12, wherein the security laminate is an identification card.

20. The security laminate according to claim 12, wherein the security laminate is a banknote.

21. A method for detecting falsified security laminates comprising the steps of:
(a) providing a security laminate as defined by claim 12;
(b) suspending the security laminate from one corner by a crocodile clip at the end of a wire;
(c) detecting a sound characteristic of the security laminate set in vibration with a hammer; and
(d) comparing the sound characteristic with the sound characteristic of an authentic security laminate.

22. A method for detecting falsified security laminates comprising the steps of:
(a) providing a security laminate as defined by claim 13;
(b) suspending the security laminate from one corner by a crocodile clip at the end of a wire;
(c) detecting a sound characteristic of the security laminate set in vibration with a hammer; and
(d) comparing the sound characteristic with the sound characteristic of an authentic security laminate.

23. A method for detecting falsified security laminates comprising the steps of:
(a) providing a security laminate as defined by claim 14;
(b) suspending the security laminate from one corner by a crocodile clip at the end of a wire;
(c) detecting a sound characteristic of the security laminate set in vibration with a hammer; and
(d) comparing the sound characteristic with the sound characteristic of an authentic security laminate.

24. A method for detecting falsified security laminates comprising the steps of:
(a) providing a security laminate as defined by claim 15;
(b) suspending the security laminate from one corner by a crocodile clip at the end of a wire;
(c) detecting a sound characteristic of the security laminate set in vibration with a hammer; and
(d) comparing the sound characteristic with the sound characteristic of an authentic security laminate.

25. A method for detecting falsified security laminates comprising the steps of:
(a) providing a security laminate as defined by claim 16;
(b) suspending the security laminate from one corner by a crocodile clip at the end of a wire;
(c) detecting a sound characteristic of the security laminate set in vibration with a hammer; and
(d) comparing the sound characteristic with the sound characteristic of an authentic security laminate.

26. A method for detecting falsified security laminates comprising the steps of:
(a) providing a security laminate as defined by claim 17;
(b) suspending the security laminate from one corner by a crocodile clip at the end of a wire;
(c) detecting a sound characteristic of the security laminate set in vibration with a hammer; and
(d) comparing the sound characteristic with the sound characteristic of an authentic security laminate.

27. A method for detecting falsified security laminates comprising the steps of:
(a) providing a security laminate as defined by claim 18;
(b) suspending the security laminate from one corner by a crocodile clip at the end of a wire;
(c) detecting a sound characteristic of the security laminate set in vibration with a hammer; and
(d) comparing the sound characteristic with the sound characteristic of an authentic security laminate.

28. A method for detecting falsified security laminates comprising the steps of:
(a) providing a security laminate as defined by claim 19;
(b) suspending the security laminate from one corner by a crocodile clip at the end of a wire;
(c) detecting a sound characteristic of the security laminate set in vibration with a hammer; and
(d) comparing the sound characteristic with the sound characteristic of an authentic security laminate.

29. A method for detecting falsified security laminates comprising the steps of:
(a) providing a security laminate as defined by claim 20;
(b) suspending the security laminate from one corner by a crocodile clip at the end of a wire;
(c) detecting a sound characteristic of the security laminate set in vibration with a hammer; and
(d) comparing the sound characteristic with the sound characteristic of an authentic security laminate.

30. A method for detecting falsified security laminates comprising the steps of:
(a) dropping said security laminate having a corner from a height of about 5 cm onto a substantially flat surface;
(b) hearing the sound made upon dropping said security laminate onto the substantially flat surface;
(c) associating the sound made upon dropping said security laminate onto the substantially flat surface with security laminates having at least one film having at least one of an elasticity modulus greater than 3.3 GPa, a tensile strength of at least 90 MPa, and a compression strength of at least 105 MPa.
